(19) United States
(12) Patent Application Publication
(10) Pub. No.: US 2005/0180141 A1
(43) Pub. Date: Aug. 18, 2005

(54) PROTECTION DEVICE FOR HIGH INTENSITY RADIATION SOURCES

(76) Inventor: Norman Arrison, Edmonton (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/709,820

(22) Filed: May 31, 2004

Related U.S. Application Data
(60) Provisional application No. 60/544,164, filed on Feb. 13, 2004.

(51) Int. Cl. F21V 7/20; F21V 29/00

(52) U.S. Cl. 362/294; 362/373; 362/345

(57) ABSTRACT

A protection device that avoids contact between a high intensity radiation source and particulate matter such as dust and debris generated by it. The protection device comprises a housing member lined with a reflective coating and in contact with a cooling unit, at least one radiation source, at least one bend in the housing device, and an opening. Any direct route from the opening to the radiation source is eliminated by the bend, reducing the possibility that particulates will contact the radiation source. This risk can be further diminished by the inclusion of at least one fluid shield generator, such as a fan. The protection device is particularly useful for protecting white light arc lamps, while in use.

### BACKGROUND OF INVENTION

The present invention relates to the field of devices that can be used to protect high intensity radiation sources from contact with debris or other foreign material, in order to prevent the creation of hot spots on the surface of these radiation sources and the concomitant failure of high intensity radiation systems.

High intensity radiation sources, such as white light arc lamps, can potentially be used in a wide variety of applications and technologies. U.S. Pat. No. 4,027,185 (issued to Nodwell et al. on May 31, 1977), U.S. Pat. No. 4,700,102 (issued to Camm et al. on Oct. 13, 1987), and U.S. Pat. No. 4,937,490 (issued to Camm et al. on Jun. 26, 1990) disclose closely similar arc lamps capable of generating white light at temperatures as high as 12,000° C.

White light arc lamps of the type taught by U.S. Pat. Nos. 4,027,185, 4,700,102 and 4,937,490 feature a hollow, elongate quartz arc chamber positioned within an elongate concave reflector. The reflector is hollow, so that liquid coolant may be circulated through the reflector to prevent it from becoming overheated under the intense heat generated by the arc chamber. For proper operation, this type of arc lamp requires an extremely clean environment. Even tiny amounts of dust or dirt on the quartz arc chamber or the reflector can cause the lamp to fail, or to function with significantly reduced effectiveness.

Consequently, due to their fragility these high intensity radiation sources can often only be used under limited and controlled circumstances. This is a serious drawback with these radiation sources that often makes their use impractical, because of high failure rate and shut down problems.

Several different attempts have been made to prevent these occurrences, but none has, to date, addressed the problem satisfactorily. One attempt involves the use of two quartz chambers that are placed around the arc (double bulb). However, a great deal of time will still be required for repairs when the second reflector is broken, as the system is still susceptible to particulate matter, such as dust, dirt, debris and other foreign material that contacts the surface of the second tube or chamber. Another attempt involves using a flow of air generated for example, by fans, to help prevent particulate matter from settling on the surface of the arc chamber. However, if the particulate matter blows back towards the arc lamp with high velocity, or if it is quite large in size, the flow of air must consequently be maintained at a sufficiently high speed to prevent particulate matter from reaching the arc lamp, which may be difficult or impossible to prevent in some applications. Another attempt involves using a moving glass shield to protect the arc lamp, which can be removed and cleaned. However, the moving glass shield itself can be broken by the particulate matter, requiring its replacement. Therefore, the applications in which these high intensity radiation sources can be used are still quite limited.

Consequently, the need has arisen for a means and device for protecting high intensity radiation sources in a wide variety of applications, to prevent particulate matter from contacting these radiation sources and damaging them during use. It would be advantageous to be able to fully benefit from the power that is generated by high intensity radiation sources in situations where significant amounts of particulate matter is generated, such as, for example, in the breaking of concrete or rock, in the treatment of metals, in the removal of barnacles from ship surfaces or other underwater surfaces, and such.

### SUMMARY OF INVENTION

The present invention discloses a device that may be used to protect high intensity radiation sources from damage that can be caused by particulate matter coming into contact with the radiation source. To reduce the possibility that particulate matter will contact the radiation source, the present invention provides a protection device in which there is an indirect path from a high intensity radiation source to an opening that emits the radiation, such that particulate matter generated by the energy from the radiation cannot travel in any direct path back towards the radiation source. The present invention is particularly useful for protecting white light arc lamps from damage by particulate matter such as debris that is generated while the arc lamp is being used.

In one aspect, the invention is a protection device for high intensity radiation sources comprising a housing member lined at least in part with a reflective coating, and with at least one straight portion and at least one bend portion; at least one radiation source, a cooling unit; and an opening, wherein said radiation source emits radiation which is reflected by said bend portion to exit through said opening.

In one embodiment, the protection device further comprises at least one shield generator, which can be positioned behind the radiation source or on a side of the housing member. The protection device is made of brass, in one embodiment, and copper in another, a thermally conductive material in another or a mixture of the above in another. In one embodiment, the reflective coating is a reflective foil. In one embodiment, the housing member is completely lined with the reflective coating. In one embodiment the radiation emitted by the radiation source is focused by the housing member. In one embodiment the housing member has two bend portions.

In another aspect, this invention is a method for preventing particulate matter from contacting the bulb of a high intensity radiation source comprising directing radiation that is emitted from the high intensity radiation source along the inside of a housing member that is: (a) lined at least in part with a reflective coating, (b) comprises at least one bend portion and (c) is cooled, towards an opening defined by the housing member, said opening being in any but a direct line from the radiation source.

In one embodiment the method further comprises directing a stream of fluid in a direction away from the high intensity radiation source and towards the opening. In one embodiment the stream of fluid is directed from behind the high intensity radiation source. In another embodiment the stream of fluid is directed from one side of the housing member. The protection device is made of brass, in one embodiment, and copper in another, a thermally conductive material in another, or a mixture of the above in another. In one embodiment, the reflective coating is a reflective foil. In one embodiment, the housing member is completely lined with the reflective coating. In one embodiment the radiation emitted by the radiation source is focused by the housing member.

### BRIEF DESCRIPTION OF DRAWINGS

The present invention, both as to its organization and manner of operation, may best be understood by reference to the following description, and the accompanying drawings wherein like reference numerals are used throughout the several views, and, in which:

FIG. 1 is a side plan view of one embodiment of the protection device of this invention.

FIG. 2 is a cross-sectional view of the embodiment illustrated in FIG. 1, taken along line 1-1.

FIG. 3 is a cross-sectional view of another embodiment, 1a, of the protection device of this invention.

FIG. 4 is a cross-sectional view of another embodiment, 1b, of the protection device of this invention.

FIG. 5 is a cross-sectional view of another embodiment, 1c, of the protection device of this invention.

FIG. 6 is a cross-sectional view of another embodiment, 1d, of the protection device of this invention.

### DETAILED DESCRIPTION

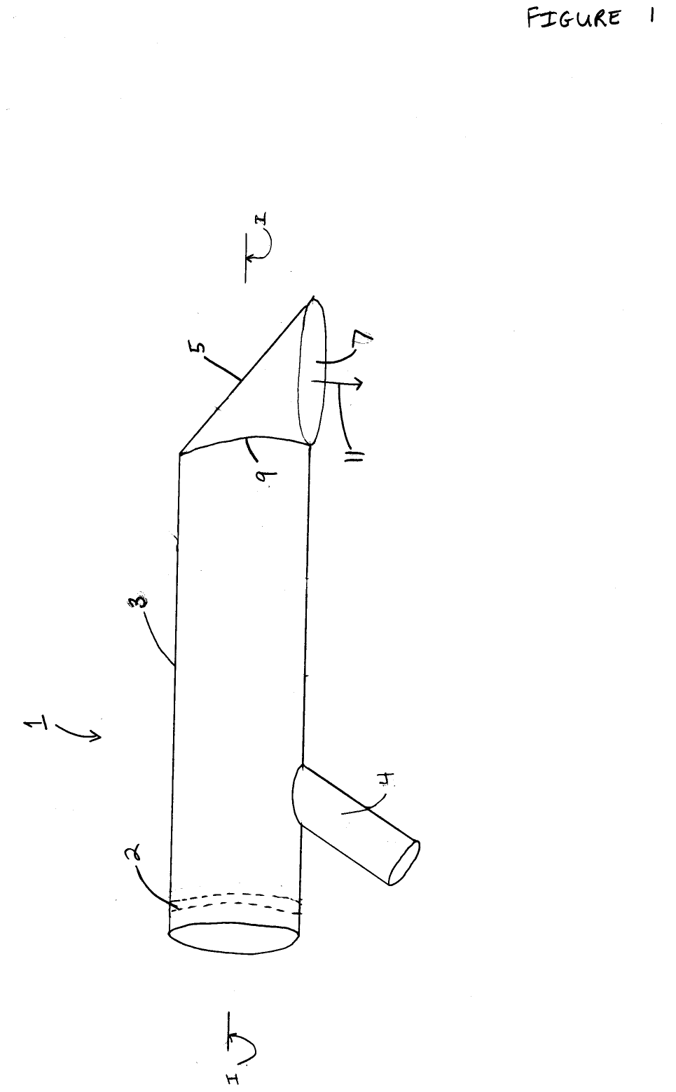

FIGS. 1-6 show various embodiments of a protection device 1 of the present invention, which comprises at least one radiation source 2, a housing member comprising a base 3 and a cooling unit 6, a reflective coating 13 inside the housing member, at least one fluid shield 4, at least one bend portion 5, and an opening 7.

In many applications in which high intensity radiation sources can or may be used, a significant amount of particulate matter, such as dust, dirt, debris and other such material is generated. This particulate matter may be propelled towards the high intensity source, where it contacts the radiation source and causes the failure of the source. To avoid the occurrence of this event, protection device 1 comprises at least one bend portion 5, where the radiation 11 emitted from radiation source 2 is reflected, on its path towards opening 7. By including one or more bend portion 5 in protection device 1, a direct route from opening 7 to radiation source 2 is avoided, thereby reducing or eliminating the possibility that debris will reach the surface of radiation source 2 and thereby cause failure of the radiation source.

“Reflection” as used herein is a reference to the bending, deflection or reversal in the direction of travel of the radiation generated by the radiation source 2, as a result of hitting a reflective material.

The housing member generally supports the various other components of protection device 1, and is therefore relatively sturdy in nature. The housing member comprises a base 3 and a cooling unit 6. Base 3 provides an inner surface to which reflective coating 13 may be applied, and an outer surface in contact with cooling unit 6. Base 3 is of a thickness that permits effective cooling of the protection device 1. In one embodiment, base 3 is about 6 mm thick.

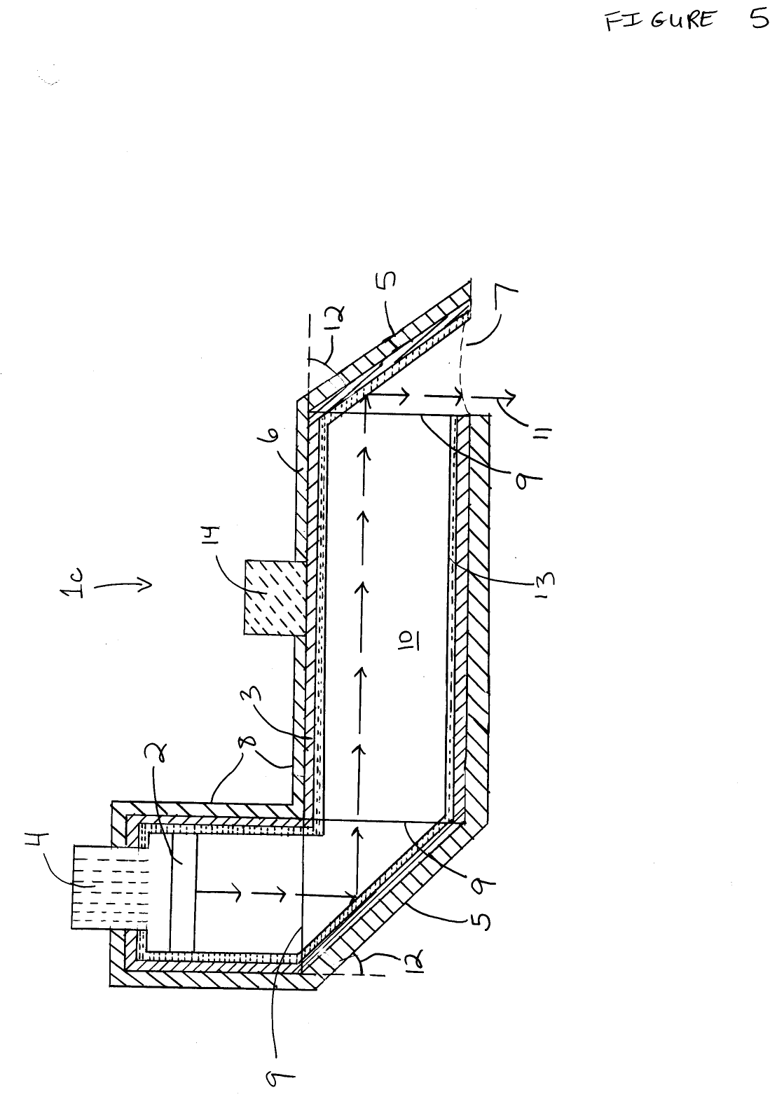

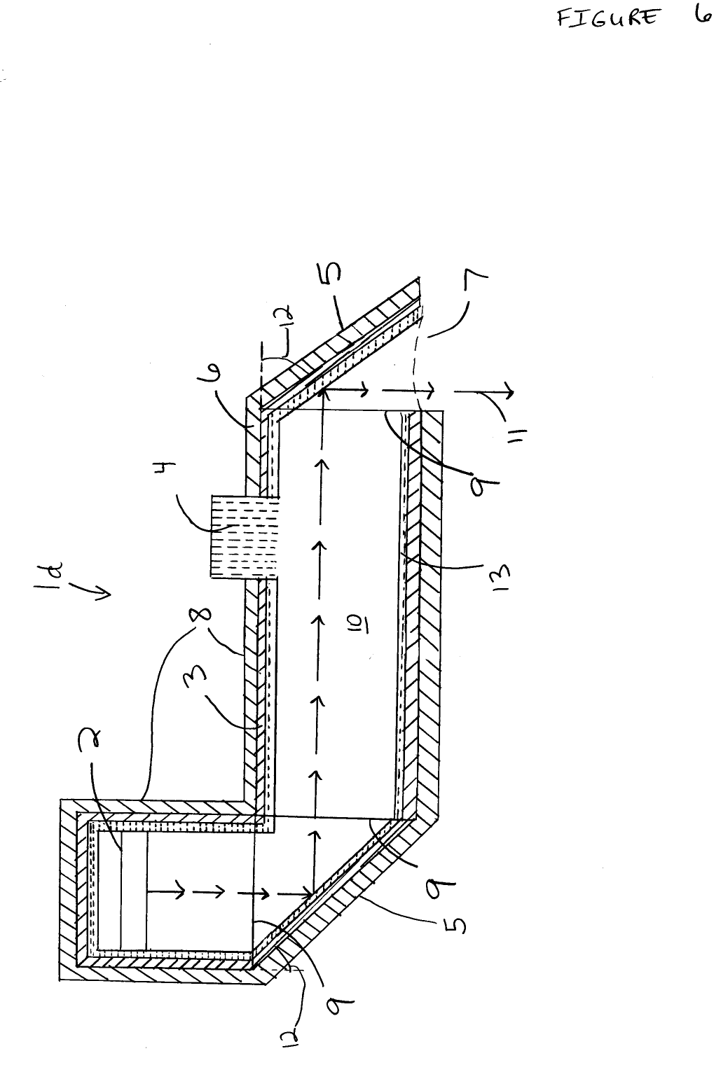

The housing member comprises at least one bend portion 5, which will reflect radiation so that there is not a direct path from radiation source 2 to opening 7. In one embodiment, housing member comprises two different portions connected to one another a relatively straight portion 8 and bend portion 5. In a simple embodiment, shown in FIG. 1-4, housing member comprises one relatively straight portion 8 and one bend portion 5. In another embodiment, shown in FIGS. 5 and 6, housing member comprises two relatively straight portions 8 and two bend portions 5. As is apparent, the number of relatively straight portions 8 and bend portions 5 may be varied, and can be the same or different, between different embodiments. The relatively straight portion 8 may be somewhat curved, along some or all of its length. The bend portion 5 may be somewhat curved, along some or all of its length.

The housing member can have any of a number of different lengths, diameters, cross-sectional shapes, and other dimensions, provided that the protection device can still function as intended herein. As is apparent, these types of parameters can be modified to better complement any equipment with which, or application in which, the high intensity radiation source will be used. As an example, which is not intended to be limiting, the length of the housing member can be as short as 10 centimetres to as long as 12 meters. Those skilled in the art will understand that the length of the housing member will vary according to the intended application of the protection device, and even the range mentioned above can be exceeded at either end. With respect to cross-sectional shape, again some non-limiting examples of useful cross-sectional shapes include round, oval, triangular, square, rectangular or hexagonal. As is apparent, the cross-sectional shape of the housing member will depend on the desired application. The same is true of diameter. The dimensions of the housing in cross-section again will depend upon the desired application.

To provide for sufficient heat conduction, the housing member can be made from a thermally conductive material, for example, a metal, a polymer or any thermally conductive material. In some embodiments, the thermally conductive material is selected from the group consisting of copper or brass, a thermally conductive material or a mixture thereof. The base 3 and cooling unit 6 may be made from the same or different materials.

Because of the intense heat generated by high intensity radiation sources such as white light arc lamps, protection device 1 is cooled by cooling unit 6, so as to prevent overheating. In one embodiment, cooling unit 6 may be a water-cooling, or other liquid-cooling, unit. In another embodiment, cooling unit 6 may an air-cooling unit. As an example, which is not meant to be limiting, a water-cooling unit may comprise two plates that are fastened together, as by bolting or welding, to form an internal chamber or cavity, or series of cooling passages and baffles, through which water is circulated to cool and prevent overheating of the protection device 1. In another embodiment cooling unit 6 may be a copper tubing system that is sautered onto, or in an otherwise thermally conductive relationship with, the outer surface of base 3. As is apparent, other types of cooling units could be used to cool protection device 1. Cooling unit 6 may entirely or only partially cover base 3, and may cover other components of protection device 1, for example any fluid shield 4 or positioning unit 14 that forms part of the protection device.

To facilitate cleaning and, among other functions, repairs, the housing member can be built using modular construction. This may permit the different portions of the housing member to be disassembled and reassembled easily. The different portions of the housing member can be easily assembled together at junctions 9. The means of connecting the various portions of housing member to each other can be many and varied. As examples, which are not intended to be limiting, the straight portions 8 and bend portions 5 may be secured together by clamps, bolts, snap connections, screw connections and the like. Although junctions 9 are shown as being at the end of the straight portions 8 or bend portions 9 in the provided Figures, the junctions may be positioned anywhere along these portions, including at the mid-point of a straight or bend portion. While not a preferred embodiment, because it is more difficult to clean and repair, it is also possible to make protection device 1 out of one piece.

Protection device 1 is particularly suited for use with, but not necessarily required to be used with, a radiation source 2 that is a “high intensity” radiation source, intensity being a measure of the time averaged energy flux. Therefore a “high intensity” radiation source generates significant amounts of energy. “Radiation” as used herein includes all electromagnetic radiation such as radio waves, IR light, visible light, UV light, x-rays and gamma rays and heat, provided that the radiation may be reflected, in whole or in part, by reflective coating 13. The radiation may be ionizing, non-ionizing, polarized, non-polarized, coherent or incoherent.

In various embodiments, radiation source 2 can generate up to 300 kilowatts of power, or can reach a temperature of 12,000° C. As is apparent, many different high intensity radiation sources may be used in protection device 1. Examples of radiation sources useful herein, which are not intended to be limiting, are different types of white light arc lamps, such as those described in U.S. Pat. Nos. 4,027,185, 4,700,102 and 4,937,490 can be used. These types of high intensity radiation sources may also be available from Vortek Industries, Vancouver, British Columbia.

For certain applications, more than one radiation source 2 may be required. Accordingly, protection device 1 may comprise more than one radiation source 2. As is apparent, the dimensions of protection device 1 may be varied to allow for the introduction of more than one radiation source 2. Further, radiation source 2, although shown in FIGS. 1-6 as being positioned at one extremity of protection device 1, could be positioned anywhere along protection device 1, provided that a direct path from opening 7 to radiation source 2 is not generated by such positioning.

Radiation source 2 can be secured in and to the housing member in a number of ways that permit the power cables and cooling water to operate and cool the radiation source. Housing member 3 may have openings that allow for the connection of radiation source 2 to a suitable external electric power supply and cooling source. The means used to secure the radiation source will depend upon the application for which the light protection device 1 is being used. For example, in one embodiment, radiation source 2 may be secured into the housing member in such a way that air, gases or particulates may be permitted to leak through gaps between the source 2 and the housing. In another embodiment radiation source 2 may be sealed in the housing member in such a manner as to prevent particulates, air, gases or other materials and substances from entering inner cavity 10 at the point of connection. This may be accomplished, for example by engineering a bayonet fitting for the cooling water and the electrical power to allow for a sealed system. In this embodiment, the protection device may be designed to open up to permit easy repair of the radiation source, if needed.

Because of the intense heat that may be generated, radiation source 2 is cooled. In some embodiments, cooling unit 6 can cool both protection device 1 generally, and radiation source 2. Another embodiment, protection device 1 may include a separate cooling unit for radiation source 2, in addition to cooling unit 6. In this embodiment, as the cathode and anode of radiation source 2 can be cooled separately from the remainder of protection device 1, and therefore to a greater extent, this may increase the useable lifespan of the radiation source and reduce cost.

As illustrated in FIGS. 1-4, bend portion 5 can be included at a single location in protection device 1. Alternately, as illustrated in FIGS. 5 and 6, bend portion 5 can be included in two different locations the protection device. It may be desirable in certain applications, to include a bend portion 5 at several different locations along the housing member, for example in situations where a significant amount of particulate matter is generated, or where the risk of contact between debris and the radiation source is heightened. The presence of more than one bend portion may, in these circumstances, provide more protection for radiation source 2 by making the path between opening 7 and the radiation source more convoluted. As is apparent, however, as the number of bend portions 5 is increased, the efficiency of transfer of heat, light and other radiation from radiation source 2 to opening 7 may be diminished.

Bend portion 5 is displaced from the longitudinal axis of relatively straight portion 8, by an angle represented by number 12 in the accompanying Figures. Angle 12 can have a number of different values. As an example, which is not intended to be limiting, angle 12 can be about 45°, which results in about a 90° reflection of the radiation 11 emitted from radiation source 2. One skilled in the art will appreciate that the size of angle 12 can be varied widely, and it preferably, but not absolutely, does not cause the radiation 11 to be reflected back towards radiation source 2.

While bend portion 5 is shown in the attached Figures to be relatively straight, it can be somewhat curved in part, or in whole, or bent within itself, provided again that such curvature or bending preferably, but not absolutely, does not cause the radiation 11 to be reflected back towards radiation source 2. Any angle or shape of bend portion 5 that permits or facilitates the reflection of radiation emitted from radiation source 2 to opening 7, and which ensures that there is no direct path from opening 7 to radiation source 2, is intended to be included herein. A single protection device 10 may have bend portions 5 that extend at different angles 12, or that differ from one another in shape (i.e., straight, curved in whole or part, or bent). In some embodiments, bend portion 5 (or relatively straight portion 8) may function additionally to focus the radiation 11, or to diffuse the radiation 11, as the case may be.

To facilitate transmission of the radiation 11 emitted from radiation source 2 to opening 7, and at times, among other functions, to maximize the amount of radiation that reaches opening 7, inner cavity 10 of protection device 1 may be lined with reflective coating 13. In some embodiments, reflective coating 13 can also function to focus radiation emitted from radiation source 2.

As the radiation emitted from radiation source 2 may be non-coherent light, in various embodiments all or substantially all surfaces of inner cavity 10 are lined with reflective coating 13. In other embodiments, limited application of reflection coating 13, for example only to bend portion 5, may be desired. As is apparent, as more reflective coating 13 is applied, the efficiency of transfer of energy from radiation source 2 to opening 7 is increased.

Reflective coating 13 can be made from a variety of materials, including a reflective foil material. In one embodiment the reflective foil is an aluminum foil material. In one embodiment the reflective coating is Anolux® available from Anolex Inc. In another embodiment the reflective coating is Anolux Miro®, also available from Anolex Inc. The use of a reflective foil in protection device 1 provides many advantages over other types of reflective coatings 13 that could be selected by one of skill in the art, for example mirrors or highly reflective metals. The reflective coating 13 will likely become damaged over time, as the protective device is used, said damage ranging from the build up of dirt and dust, to an actual destruction of the reflective coating from the impact particulate matter. The use of reflective foil material has many advantages such as ease of replacement, low replacement and maintenance costs, as well as the capability to reflect radiation efficiently. In fact, a reflective foil material can have the property of reflecting over 95% of the radiation emitted from radiation source 2. Moreover, although a foil-based reflective coating may lose some reflecting efficiency if hit by particulate matter, because it is foil-based, it may still reflect relatively well the radiation that is emitted from radiation source 2 until it has been damaged a high number of times. At this point, operation of the protective device 1 can be stopped and reflective coating 13 can be replaced. However, as is apparent, in order for a foil-based reflective coating to maintain its reflective properties, the material to which it is affixed is preferably cooled to prevent melting. As described previously, cooling unit 6 is included in the housing member.

Reflective coating 13 may be affixed to the housing member in a variety of different ways, including, for example, with adhesive tape. In one embodiment, two-sided thermally conductive adhesive tape may be used to affix the reflective coating to the thermally conductive material. Use of a modular construction of the housing member can greatly facilitate the cleaning of all internal surfaces and the replacement of reflective coating 13 as well as any radiation source 2 contained within, since all components can be separated and reassembled easily.

To further prevent particulate material from contacting the radiation source 2, a fluid shield may be used. The fluid shield is generated by shield generator 4, which creates a positive driving force that propels a fluid, i.e., air, inert gases, water, etc., towards opening 7 and away from radiation source 2. Examples of useful shield generators include fans, cooling fins, blowers or pumps. In one embodiment, shield generator 4 also comprises a filter to prevent particulate material from entering inner cavity 10 of protection device 1 from the shield generator itself.

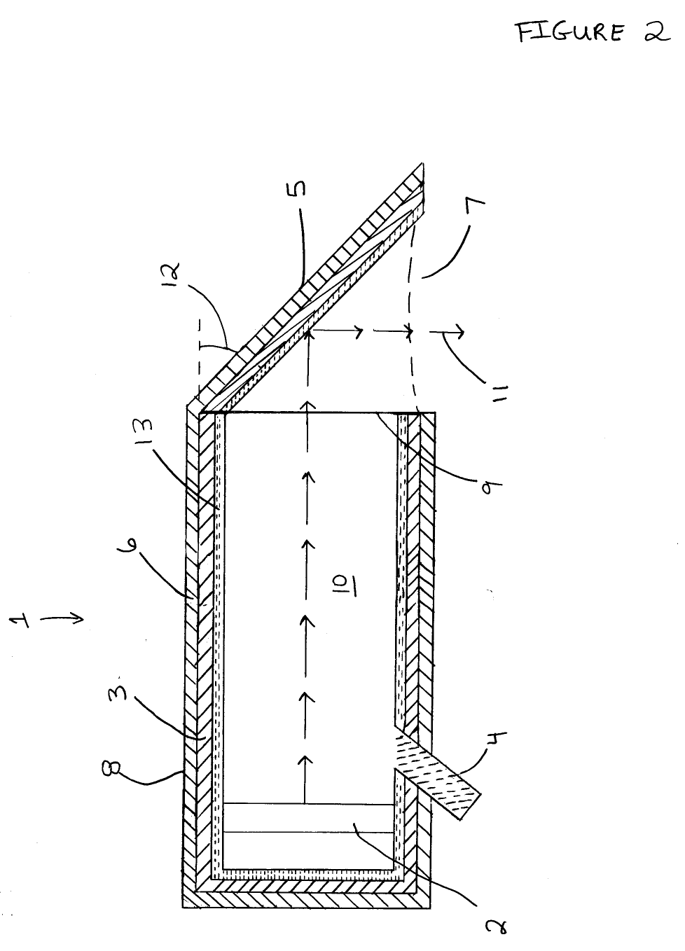

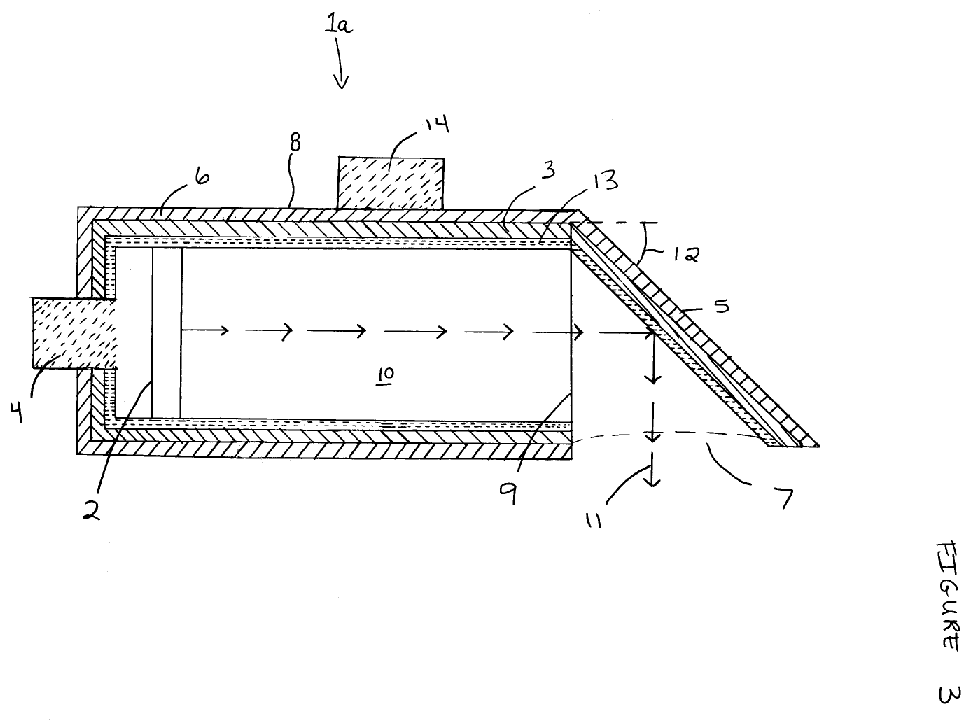

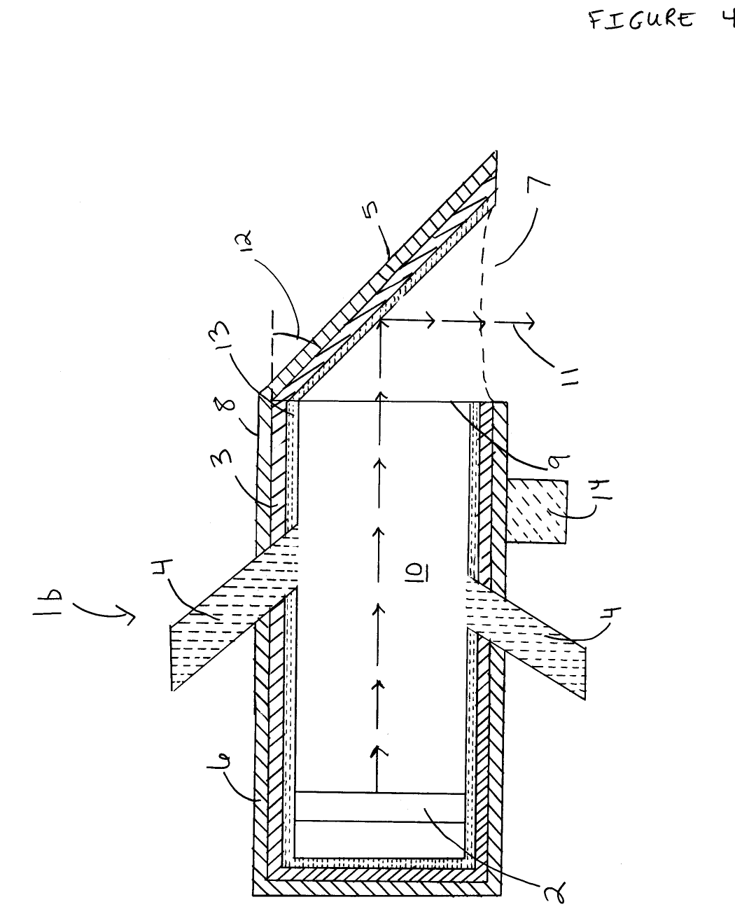

As illustrated in FIGS. 1, 2 and 6, shield generator 4 can be located on one side of protection device 1. In these embodiments, shield generator 4 can be angled with respect to the longitudinal axis of the protective device, as shown in FIG. 2 or 4. Alternately, as illustrated in FIGS. 3 and 5, shield generator 4 can be positioned behind radiation source 2. For certain applications, specifically applications where a greater amount of particulate matter, or larger particulate matter, may be generated, it may desirable to use more than one shield generator 4, for example at several different locations on protection device 1, as illustrated in FIG. 4. As is apparent, different shield generators 4 could be used on protection device 1, and more than two shield generators 4 may be used.

Protection device 1 may be portable or fixed. It may additionally have a positioning unit 14, attached to protection device 1. Positioning unit 14 can take various forms such as, for example, a handle. Alternately or in addition, positioning unit 14 may also be a type of stand on which protection device 1 is mounted. In one embodiment, positioning unit 14 comprises a hydraulic system. In another embodiment, positioning unit 14 comprises a screw drive. As is apparent, other types of positioning units can be used depending on the intended application. For example, a specific positioning unit may be required if protection device 1 is to be used under water.

While the invention has been described in conjunction with the disclosed embodiment, it will be understood that the invention is not intended to be limited to these embodiments. On the contrary, the invention is intended to cover alternatives, modifications and equivalents, which may be included within the spirit and scope of the invention. Various modifications will remain readily apparent to those skilled in the art, since the generic principles of the present invention have been defined herein specifically to describe protection devices for high intensity radiation sources.

1. A protection device for high intensity radiation sources comprising:
(a) a housing member lined at least in part with a reflective coating, and with at least one bend portion;
(b) at least one radiation source in the housing member;
(c) a cooling unit that cools the housing member; and
(d) an opening,
wherein said radiation source emits radiation which is reflected by said bend portion to exit through said opening.

2. The protection device of claim 1 further comprising at least one relatively straight portion.

3. The protection device of claim 2 further comprising at least one shield generator.

4. The protection device of claim 3, wherein at least one shield generator is behind the radiation source.

5. The protection device of claim 3, wherein at least one shield generator is on a side of the housing member.

6. The protection device of claim 1, wherein the housing member is made from: (a) brass, (b) copper, (c) a heat conducting material, or (d) a mixture thereof.

7. The protection device of claim 3, wherein the housing member is made from: (a) brass, (b) copper, (c) a heat conducting material, or (d) a mixture thereof.

8. The protection device of claim 1, wherein the reflective coating is a reflective foil.

9. The protection device of claim 3, wherein the reflective coating is a reflective foil.

10. The protection device of claim 1, wherein the housing member is completely lined with the reflective coating.

11. The protection device of claim 3, wherein the housing member is completely lined with the reflective coating.

12. The protection device of claim 1, wherein the radiation emitted by the radiation source is focused by the housing member.

13. The protection device of claim 3, wherein the radiation emitted by the radiation source is focused by the housing member.

14. The protection device of claim 2, wherein the housing member has two bend portions.

15. The protection device of claim 3, wherein the housing member has two bend portions.

16. A method for preventing particulate matter from contacting a bulb of a high intensity radiation source comprising directing radiation that is emitted from the high intensity radiation source along the inside of a housing member that is: (a) lined at least in part with a reflective coating and (b) is cooled, towards an opening defined by the housing member, said opening being in any but a direct line of travel, along the inside of the housing member, from the radiation source.

17. The method of claim 16, further comprising directing a stream of fluid in a direction away from the high intensity radiation source and towards the opening.

18. The method of claim 17, further comprising directing the stream of fluid from behind the high intensity radiation source.

19. The method of claim 17, further comprising directing the stream of fluid from one side of the housing member.

20. The method of claim 16, wherein the housing member is made from: (a) brass, (b) copper, (c) a heat conducting material, or (d) a mixture thereof.

21. The method of claim 17, wherein the housing member is made from: (a) brass, (b) copper, (c) a heat conducting material, or (d) a mixture thereof.

22. The method of claim 16, wherein the reflective coating is a reflective foil.

23. The method of claim 17, wherein the reflective coating is a reflective foil.

24. The method of claim 16, wherein the housing member is completely lined with the reflective coating.

25. The method of claim 17, wherein the housing member is completely lined with the reflective coating.

26. The method of claim 16, wherein the radiation emitted by the radiation source is focused by the housing member.

27. The method of claim 17, wherein the radiation emitted by the radiation source is focused by the housing member.

28. The protection device of claim 1, wherein the radiation source is secured in the housing using a sealing mechanism that prevents air, gas, other fluids and particulates from entering the housing.

29. The method of claim 16, further comprising sealing the housing member at the position where the high intensity radiation source is connected to the housing member, so that air, gas, other fluids and particulates cannot enter into the housing member from that position.
